(19) United States
(12) Patent Application Publication
(10) Pub. No.: US 2012/0182582 A1
(43) Pub. Date: Jul. 19, 2012

(54) IMAGE FORMING APPARATUS AND METHOD OF CONTROLLING THE SAME

(76) Inventor: Tasuku NAGAI, Kanagawa (JP)

(21) Appl. No.: 13/337,474

(22) Filed: Dec. 27, 2011

(30) Foreign Application Priority Data
Jan. 17, 2011 (JP) 2011-007184

(51) Int. Cl. G06K 15/00

(52) U.S. Cl. 358/1.16

(57) ABSTRACT

An image forming apparatus includes a buffer-full notification unit that gives a notification that a predetermined amount of image data is stored in a first buffer, a second buffer that is connected to the first buffer through a bus and temporarily stores image data read from the first buffer, an image forming member that forms an image on a medium on the basis of image data stored in the second buffer, and a read control unit that acquires image data stored in the first buffer through the bus and stores acquired image data in the second buffer, when a read command to read image data stored in the first buffer to store the read image data in the second buffer is generated and the notification is given from the buffer-full notification unit.

### CROSS-REFERENCE TO RELATED APPLICATIONS

The present application claims priority to and incorporates by reference the entire contents of Japanese Patent Application No. 2011-007184 filed in Japan on Jan. 17, 2011.

### BACKGROUND OF THE INVENTION

1. Field of the Invention

An embodiment of the invention relates to an image forming apparatus and a method of controlling the same.

2. Description of the Related Art

In the related art, an image forming apparatus is known in which an engine unit and a controller unit are connected together by a universal bus, such as PCI Express (Registered Trademark), and when a plotter (image forming member) of the engine unit requests image data, image data is prepared in the buffer of an ASIC in front of the plotter (on the controller unit side) of the engine unit in a preview manner so as to transfer image data prepared on the memory of the controller unit to the plotter without delay.

In the related art, an image forming apparatus (see Japanese Patent Application Laid-open No. 2010-64329) is known in which a notification of read permission is sent from the controller unit to the engine unit and the engine unit which receives the notification requests the controller unit to transfer image data in a case where image data has been stored in a predetermined number of toggle buffers of the memory, in order to prevent defective image data from being transferred to the engine unit, when a request to transfer image data is issued from the engine unit in a state where image data is not prepared on the memory.

However, in the image forming apparatus of the related art, even when image data is prepared on the memory, if a preview process of image data is performed in a state where image data is not prepared in the buffer of the ASIC of the controller unit, there is a problem in that unauthorized image data is transferred to the plotter, causing degradation in quality of image formation.

### SUMMARY OF THE INVENTION

It is an object of the present invention to at least partially solve the problems in the conventional technology.

An image forming apparatus includes: a memory that stores image data; a first buffer that temporarily stores image data read from the memory; a buffer-full notification unit that gives a notification that a predetermined amount of image data is stored in the first buffer; and an image forming unit, the image forming unit having a second buffer that is connected to the first buffer through a bus and temporarily stores image data read from the first buffer, an image forming member that forms an image on a medium on the basis of image data stored in the second buffer, and a read control unit that acquires image data stored in the first buffer through the bus and stores acquired image data in the second buffer, when a read command to read image data stored in the first buffer to store the read image data in the second buffer is generated and the notification is given from the buffer-full notification unit.

A method of controlling an image forming apparatus including a memory that stores image data, a first buffer that temporarily stores image data read from the memory, a second buffer that is connected to the first buffer through a bus and temporarily stores image data read from the first buffer, and an image forming member that forms an image on a medium on the basis of image data stored in the second buffer. The method includes: giving a notification that a predetermined amount of image data is stored in the first buffer; and acquiring image data stored in the first buffer through the bus and storing acquired image data in the second buffer when a read command to read image data stored in the first buffer to store the read image data in the second buffer is generated and the notification is given in the giving of the notification.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating the hardware configuration of a multi-function peripheral according to the present embodiment;

FIG. 2 is a block diagram illustrating the details of an ASIC(C) of a first embodiment;

FIG. 3 is a block diagram illustrating the details of an ASIC(E) of the first embodiment;

FIG. 4 is a sequence diagram illustrating the flow of a process in a multi-function peripheral of the first embodiment;

FIG. 5 is a block diagram illustrating the details of an ASIC(C) of a second embodiment;

FIG. 6 is a sequence diagram illustrating the flow of a process in a multi-function peripheral having the ASIC(C) of the second embodiment;

FIG. 7 is a block diagram illustrating the details of an ASIC(C) of a third embodiment; and

FIG. 8 is a block diagram illustrating the details of an ASIC(E) of the third embodiment.

### DETAILED DESCRIPTION OF THE PREFERRED EMBODIMENTS

Hereinafter, embodiments of the invention will be described with reference to the accompanying drawings.

An image forming apparatus according to an embodiment is an image forming apparatus, such as a multi-function peripheral (MFP) or a printer, which can form an image on a medium, such as a recording sheet. The following description will be provided as to a case where the invention is applied to a digital multi-function peripheral having a scanner function, a copy function, a printer function, and a facsimile function.

In the following description, the same constituent elements in a plurality of embodiments are represented by the common reference numerals, and overlapping description will not be repeated.

### First Embodiment

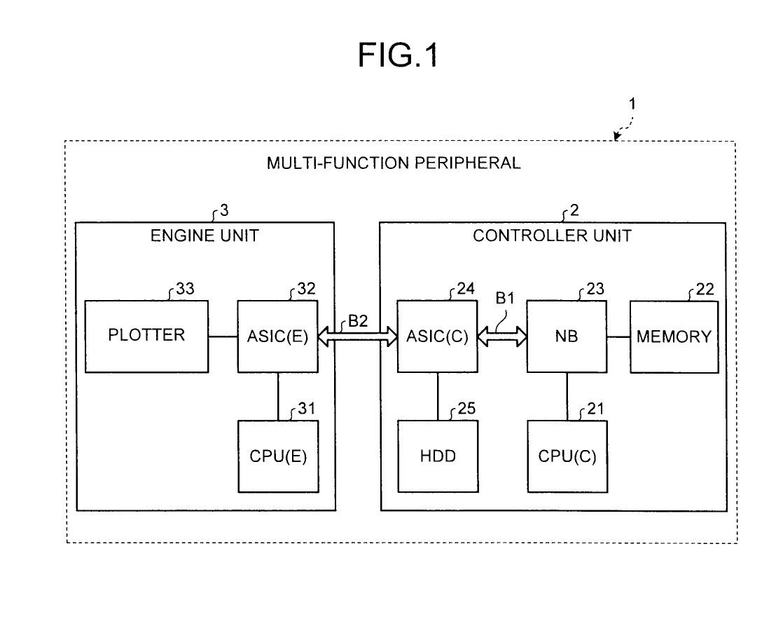

FIG. 1 is a block diagram illustrating the hardware configuration of a multi-function peripheral 1 according to a first embodiment.

As illustrated in FIG. 1, the multi-function peripheral 1 of the present embodiment mainly includes a controller unit 2 which controls various processing operations in the multi-function peripheral 1, and an engine unit (image forming unit) 3 which performs a process for reading an image formed on a medium, such as a recording sheet of paper, by a scanner (image reading member) (not shown), a process for forming an image on a medium, such as a recording sheet, by a plotter (image forming member) 33, or the like.

The controller unit 2 has a Central Processing Unit (CPU) (C) 21, a memory 22, a North Bridge (NB) 23, an Application Specific Integrated Circuit (ASIC) (C) 24, and Hard Disk Drive (HDD) 25, and the like.

The CPU(C) 21 is a first control unit which performs overall control of the multi-function peripheral 1, in particular, controls various processing operations in the controller unit 2.

The memory 22 is an image data storing memory which reads a predetermined amount of image data from among image data stored in the HDD 25 and stores read image data.

The North Bridge (NB) 23 is a chip which controls connection among the CPU(C) 21, the memory 22, and the ASIC(C) 24.

The ASIC(C) 24 is a first image processing unit which performs various image processes (for example, image data rotation, edition, and the like) in the controller unit 2.

The Hard Disk Drive (HDD) 25 is a storage device which stores image data (hereinafter, referred to as “scanner data”) read by a scanner (image reading unit) (not shown) and subjected to necessary image processes, image data (hereinafter, referred to as “reception data”) received from a host device (not shown), or the like.

The NB 23 and the ASIC(C) 24 are connected by a universal bus B1, such as Peripheral Component Interface (PCI) Express.

The engine unit (image forming unit) 3 has a CPU(E) 31, an ASIC(E) 32, the plotter (image forming member) 33, and the like.

The CPU(E) 31 is a second control unit which controls various processing operations in the engine unit 3.

The ASIC(E) 32 is a second image processing unit which performs various image processes (for example, an image process on image data read by the scanner (image reading unit) (not shown), an image process on image data to be transferred to the plotter (image forming member) 33, and the like) in the engine unit 3.

Examples of the image process on image data read by the scanner (image reading unit) (not shown) include a scanner interface (I/F) process, a shading correction process, a filter process, a color correction process, a variable magnification process, a binarization process, and the like.

Examples of the image process on image data to be transferred to the plotter (image forming member) 33 include printer image processes, such as an error diffusion method, or printer γ conversion.

The plotter 33 is an image forming member which forms an image based on received image data on a medium, such as a recording sheet of paper, through an electrophotography process using a laser beam, or the like.

In the multi-function peripheral 1 of the present embodiment, the ASIC(C) 24 of the controller unit 2 and the ASIC(E) 32 of the engine unit 3 are connected together by a universal bus B2, such as PCI Express.

In the example of FIG. 1, though not particularly illustrated, the multi-function peripheral 1 of this the embodiment has an operating and display unit serving as a user interface unit, which has an operating unit receiving an operation input from a user, a display unit displaying various kinds of information notified to the user, and the like; a communication interface unit which is configured for communication connection to the external host device; a facsimile unit which performs facsimile communication; and the like.

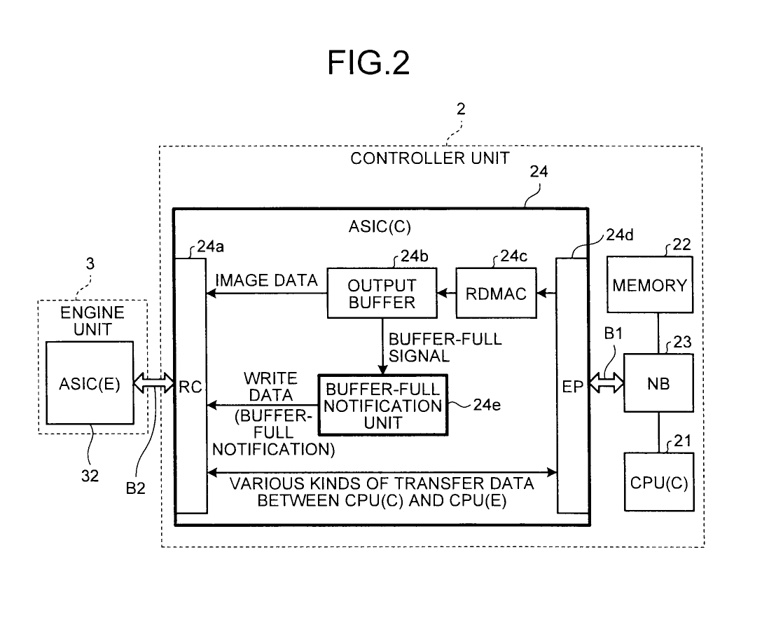

FIG. 2 is a block diagram illustrating the details of the ASIC(C) 24 of the controller unit 2.

As illustrated in FIG. 2, the ASIC(C) 24 has an Root Complex (RC) 24a, an output buffer (first buffer) 24b, an Read Direct Memory Access Controller (RDMAC) 24c, an End Point (EP) 24d, and a buffer-full notification unit 24e.

Here, the Root Complex (RC) 24a as a target receives a read request from the ASIC(E) 32 of the engine unit 3 through the universal bus B2, and controls reading from the output buffer 24b. If receiving a write request from the buffer-full notification unit 24e, the RC 24a as a master issues a write request to the ASIC(E) 32 through the universal bus B2.

The output buffer 24b is a buffer which temporarily stores image data read from the memory 22. When data for buffer capacity is filled (stored), the output buffer 24b of the first embodiment sends, to the buffer-full notification unit 24e, a buffer-full signal indicating that the output buffer 24b is filled (buffer full).

The Read DMAC (RDMAC) 24c is configured to read image data from the memory 22.

The End Point (EP) 24d as a master issues a read request to the memory 22 through the bus B1, and as a target performs a data transfer process between the CPU(C) 21 and the CPU(E) 31 through a communication buffer 32g of the ASIC(E) 32.

The buffer-full notification unit 24e is a unit which gives notification that the output buffer 24b is filled (buffer full). Specifically, when the buffer-full signal from the output buffer 24b has been detected, the buffer-full notification unit 24e issues a write request to the RC 24a. The address of a write request destination is the address of a register 32e which is disposed in the target space of the ASIC(E) 32.

In the example of FIG. 1 or 2, though not particularly illustrated, the controller unit 2 of the present embodiment includes a South Bridge (SB), a memory, such as a Read Only Memory (ROM) or a Random Access Memory (RAM), which stores or develops programs or various kinds of data, and the like.

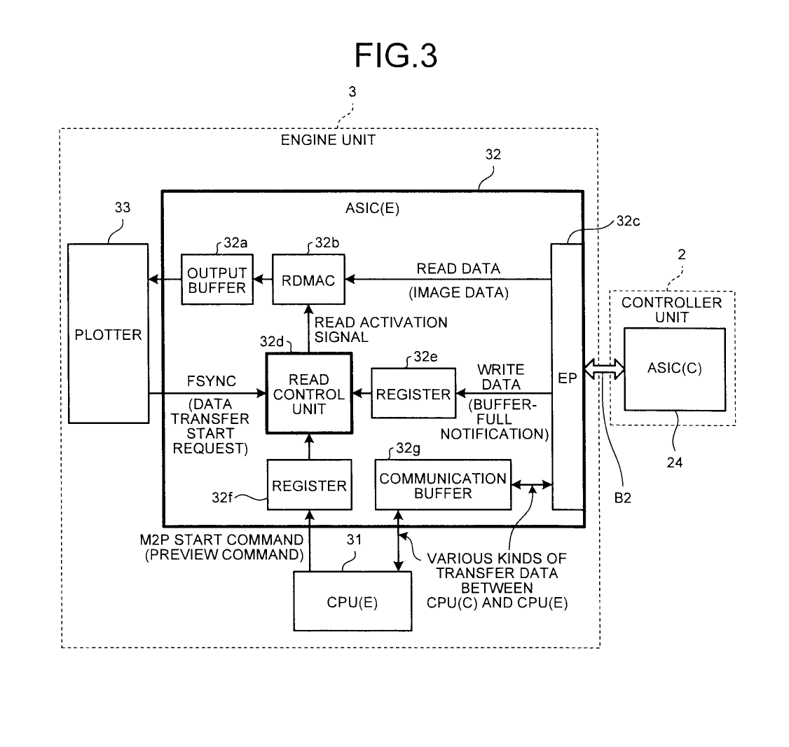

FIG. 3 is a block diagram illustrating the details of the ASIC(E) 32 of the engine unit 3.

As illustrated in FIG. 3, the ASIC(E) 32 includes an output buffer (second buffer) 32a, an RDMAC 32b, an EP 32c, a read control unit 32d, the register 32e, a register 32f, and a communication buffer 32g.

Here, the output buffer (second buffer) 32a is a line buffer which is configured to temporarily store image data read from the output buffer 24b of the ASIC(C) 24.

The RDMAC 32b is configured to read image data from the output buffer 24b of the ASIC(C) 24.

The EP 32c as a master issues a read request to the ASIC(C) 24 through the bus B2. The EP 32c as a target receives a write request from the ASIC(C) 24, and performs writing to the register 32e.

The read control unit 32d controls the driving timing of the RDMAC 32b. When a buffer-full notification from the ASIC(C) 24 and an M2P start command (preview command) from the CPU(C) 21 are received, the read control unit 32d drives the RDMAC 32b, and reads image data filled (stored) in the output buffer 24b of the ASIC(C) 24 by the RDMAC 32b (that is, acquires image data filled (stored) in the output buffer 24b through the universal bus B2 and stores acquired image data in the output buffer 32a). After image data has been filled (stored) in the output buffer 32a, if receiving an image data transfer request (FSYNC) from the plotter (image forming member) 33, the read control unit 32d starts data transfer of image data which is Memory to Plotter (M2P) data to the plotter 33.

The term “M2P start command” (preview command) used herein refers to a read command for reading image data stored in the output buffer 24b to the output buffer 32a.

The register 32f is a register which is disposed in the target space of the ASIC(E) 32 and to which write data (buffer-full notification) sent from the ASIC(C) 24 and received through the EP 32c is written.

The register 32f is a register which is disposed in a space accessible from the CPU(E) 31 and to which the M2P start command (preview command) sent from the CPU(E) 31 is written.

The communication buffer 32g is a buffer which is configured to temporarily store various kinds of transfer data transmitted and received between the CPU(E) 31 and the CPU(C) 21.

In the example of FIG. 1 or 3, though not particularly illustrated, the engine unit 3 of the present embodiment includes a control unit which controls the driving of the plotter (image forming member) 33 or the scanner (image reading unit) (not shown).

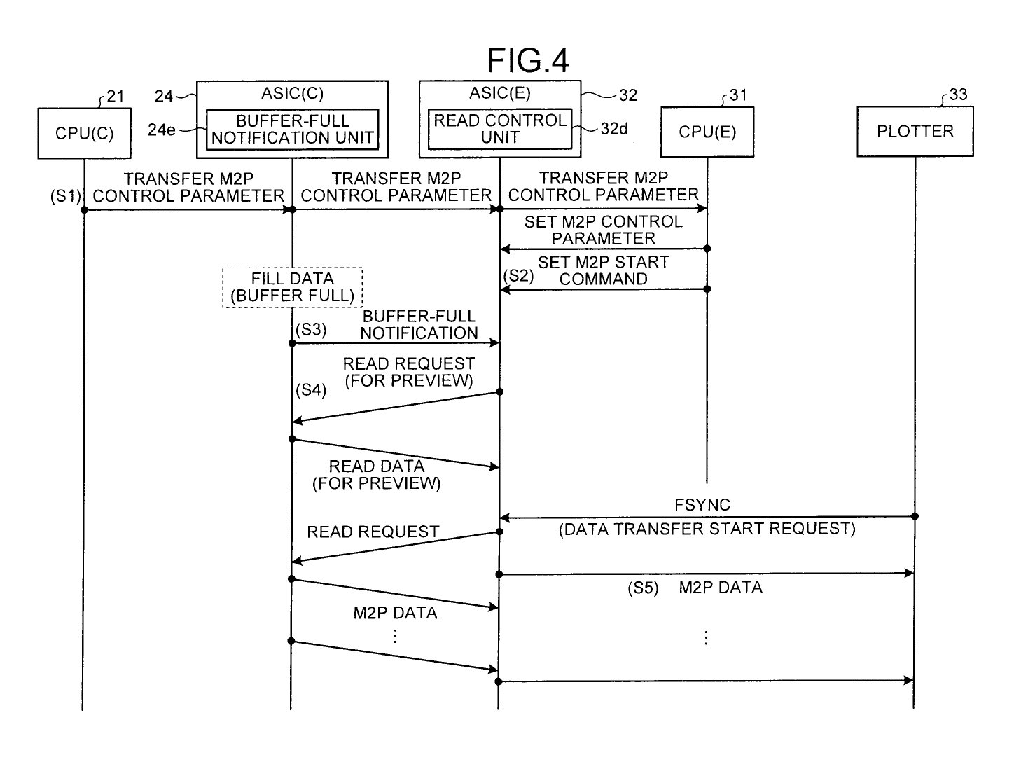

FIG. 4 is a sequence diagram illustrating the flow of a process in the multi-function peripheral 1 of the first embodiment.

As illustrated in FIG. 4, first, in Step S1, various M2P control parameters are transferred among the CPU(C) 21, the ASIC(C) 24, the ASIC(E) 32, and the CPU(E) 31 to be set at the ASIC(E) 32, at a predetermined timing, such as image formation.

Thereafter, in Step S2, the CPU(E) 31 sets the M2P start command (preview command) in the ASIC(E) 32.

Subsequently, in Step S3, in the ASIC(C) 24, when the buffer-full notification unit 24e receives the buffer-full signal from the output buffer 24b and detects the buffer full of the output buffer 24b, the buffer-full notification unit 24e issues write data as a write request to the RC 24a. When this happens, write data is written to the register 32e of the ASIC(E) 32 through the RC 24a. Thus, the buffer-full notification is given to the read control unit 32d of the ASIC(E) 32.

Subsequently, in Step S4, the ASIC(E) 32 starts a preview process for a line buffer. That is, the ASIC(E) 32 reads data for a line buffer from among data filled (stored) in the output buffer 24b of the ASIC(C) 24, and stores read image data in the output buffer 32a. After data for a line buffer has been filled (stored) in the output buffer 32a by the preview process, the ASIC(E) 32 stands by for the reception of the image data transfer request (FSYNC) from the plotter (image forming member) 33.

In Step S5, if the image data transfer request (FSYNC) is received from the plotter 33, the ASIC(E) 32 starts to transfer image data to the plotter 33. Specifically, the ASIC(E) 32 repeatedly performs a series of processes for transferring image data filled (stored) in the output buffer 32a in a preview manner in Step S4 to the plotter 33, reading image data for the next line buffer from the output buffer 24b of the ASIC(C) 24 after the transfer, filling (storing) image data in the output buffer 32a, and transferring image data stored in the output buffer 32a to the plotter 33.

That is, according to the first embodiment, when the ASIC(E) 32 of the engine unit 3 performs the preview process of image data, since image data is constantly prepared in the output buffer 24b of the ASIC(C) 24 of the controller unit 2, unauthorized or defective image data can be prevented from being transferred to the plotter (image forming member), thereby preventing degradation in quality of image formation.

According to the first embodiment, since the buffer-full notification can be given by hardware without intervening software, the ASIC(E) 32 can issue a data request faster. According to the first embodiment, since it is not necessary to add a dedicated signal line between the ASIC(E) 32 and the ASIC(C) 24, overhead can be suppressed from the viewpoint of cost.

### Second Embodiment

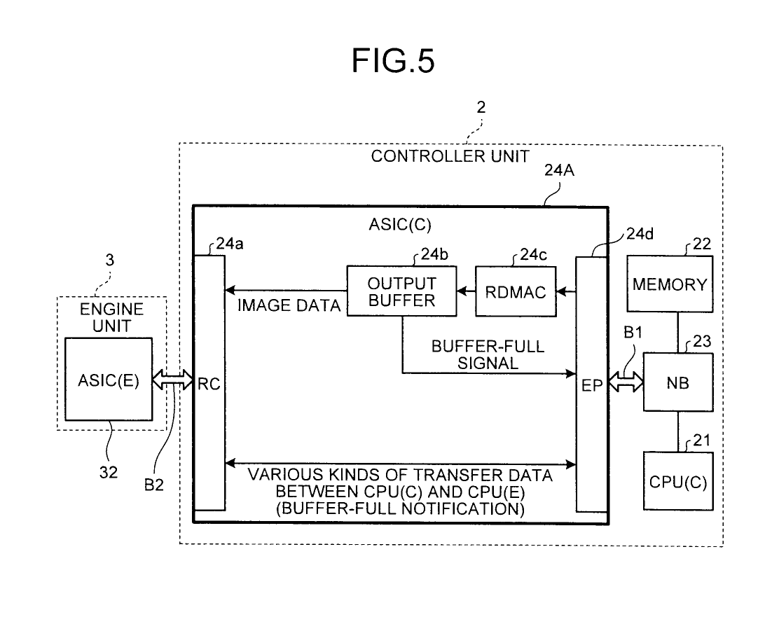

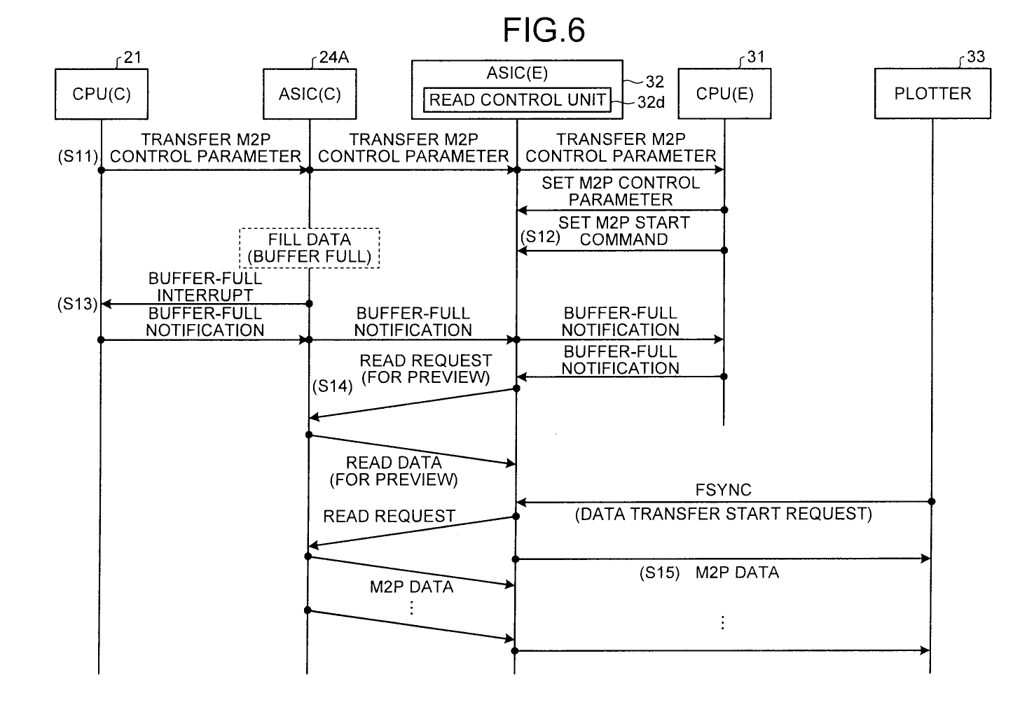

Next, a second embodiment will be described with reference to FIGS. 5 and 6. The second embodiment is different from the first embodiment in that the ASIC(C) 24 of the controller unit 2 of the first embodiment is changed to an ASIC(C) 24A.

Specifically, as illustrated in FIG. 5, the ASIC(C) 24A of the second embodiment has a configuration in which the buffer-full notification unit 24e in the ASIC(C) 24 of the first embodiment is not provided.

In the ASIC(C) 24A of the second embodiment, when the output buffer 24b is filled with data for buffer capacity, the buffer-full signal is sent to the EP 24d. The EP 24d which has received the buffer-full signal issues an interrupt to the CPU(C) 21 through the bus B1 (that is, gives buffer-full notification). Thereafter, the CPU(C) 21 which has received the interrupt gives the buffer-full notification to the ASIC(E) 32 through the CPU(E) 31 by software.

FIG. 6 is a sequence diagram illustrating the flow of a process in the multi-function peripheral 1 in which the ASIC(C) 24A of the second embodiment is mounted instead of the ASIC(C) 24 of the controller unit 2 in the multi-function peripheral 1 of the first embodiment.

In the sequence of FIG. 6, the processing of Steps S11, S12, S14, and S15 is the same as the processing of Steps S1, S2, S4, and S5 in the sequence of FIG. 4, and only the processing of Step S13 is different from the processing of Step S3. For this reason, hereinafter, description of the same processing will not be repeated.

In Step S13 of the sequence of FIG. 6, in the ASIC(C) 24A, if the EP 24d receives the buffer-full signal from the output buffer 24b, a buffer-full interrupt is issued to the CPU(C) 21 through the bus B1. When this happens, the CPU(C) 21 which has received the buffer-full interrupt gives buffer-full notification to the CPU(E) 31 through the communication buffer 32g of the ASIC(E) 32. The CPU(E) 31 which has receives the buffer-full notification gives buffer-full notification to the ASIC(E) 32.

In the first embodiment, the buffer-full notification is given by hardware. In contrast, in the second embodiment, unlike the first embodiment, the buffer-full notification is given by software.

That is, according to the second embodiment, since the CPU(C) 21 of the controller unit 2 can recognize the buffer full, the buffer-full notification can be given from the CPU(C) 21 to the ASIC(E) 32 by software, and hardware overhead for the buffer-full notification can be suppressed.

### Third Embodiment

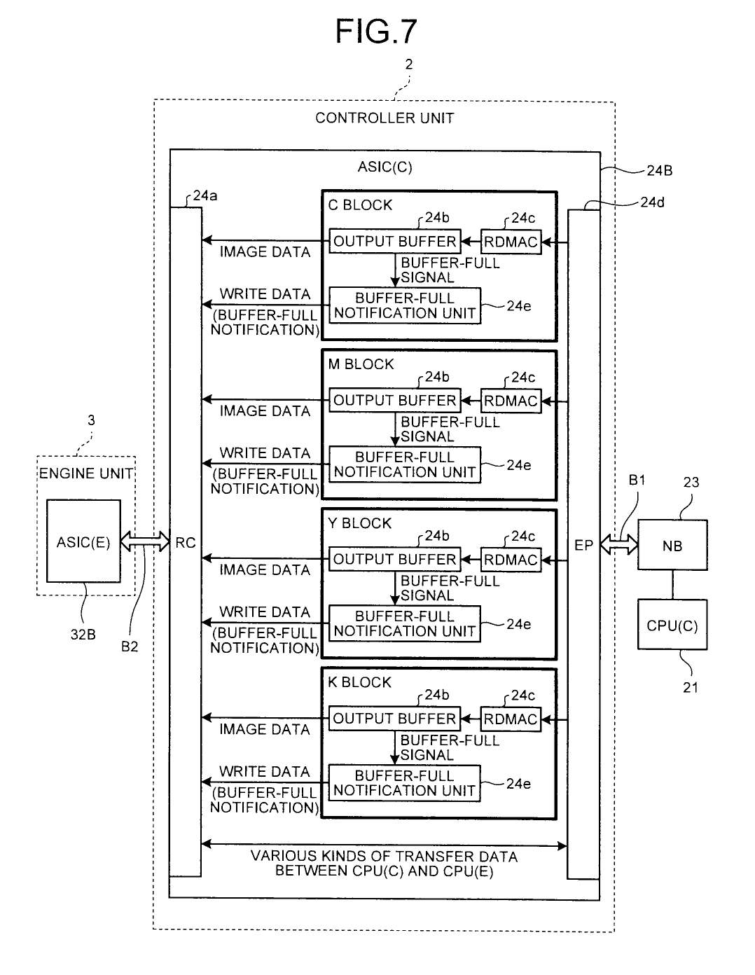

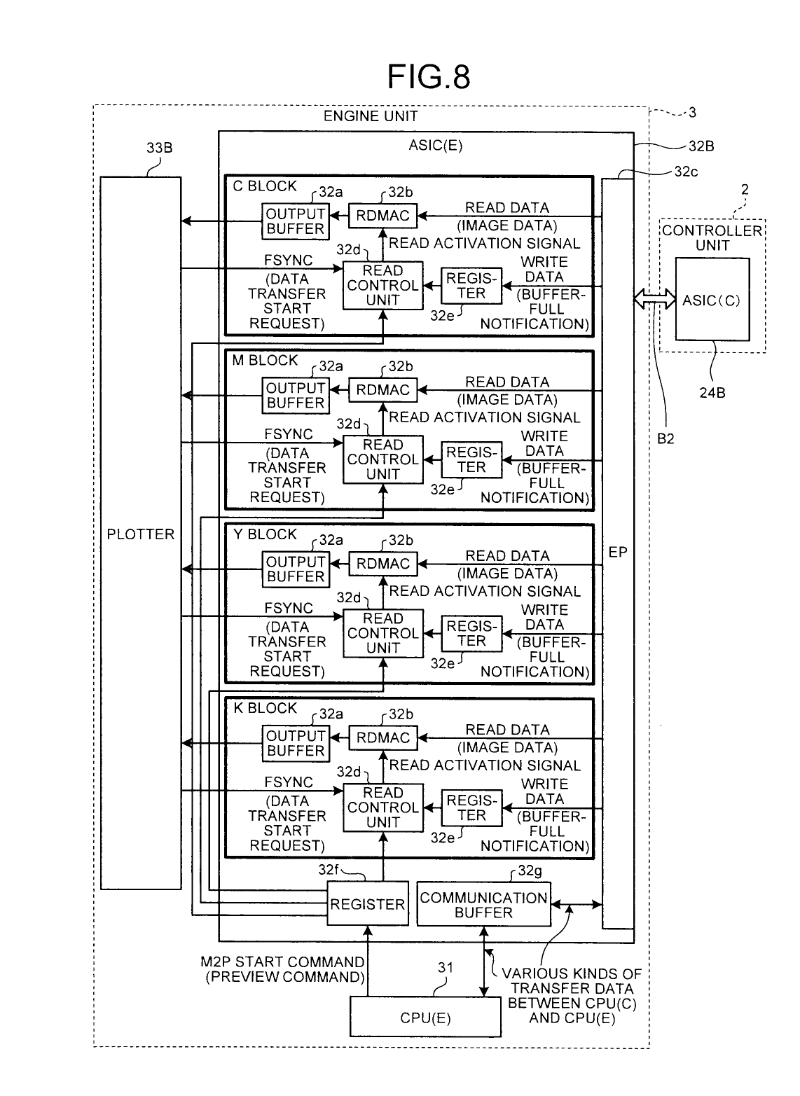

Next, a third embodiment will be described with reference to FIGS. 7 and 8. The third embodiment is different from the first embodiment in that the ASIC(C) 24 of the controller unit 2 of the first embodiment is changed to an ASIC(C) 24B, the ASIC(E) 32 of the engine unit 3 of the first embodiment is changed to an ASIC(E) 32B, and the plotter (image forming member) 33 is changed to a plotter (image forming member) 33B.

Specifically, as illustrated in FIG. 7, in the ASIC(C) 24B of the third embodiment, the output buffer 24b, the RDMAC 24c, and the buffer-full notification unit 24e which are constituent elements excluding the RC 24a and the EP 24d in the ASIC(C) 24 of the first embodiment are prepared for each block (each color) of C (cyan), M (magenta), Y (yellow), and K (black). The plotter (image forming member) 33B of the third embodiment includes an output mechanism for each block (each color).

As illustrated in FIG. 8, in the ASIC(E) 32B of the third embodiment, the output buffer 32a, the RDMAC 32b, the read control unit 32d, and the register 32e which are constituent elements excluding the EP 32c, the register 32f, and the communication buffer 32g in the ASIC(E) 32 of the first embodiment are prepared for each block (each color) of C (cyan), M (magenta), Y (yellow), and K (black).

That is, according to the third embodiment, since a plurality of pieces of image data corresponding to the respective blocks (respective colors) of C (cyan), M (magenta), Y (yellow), and K (black) can be transferred in parallel, image data can be transferred at high speed.

In addition to the first to third embodiments, an embodiment in which the second embodiment and the third embodiment are combined together may be implemented. That is, like the ASIC(C) 24A of the second embodiment, the ASIC(C) 24B of the third embodiment may have a configuration in which the buffer-full notification unit 24e is not provided.

Although the above description has been provided on the basis of the exemplary embodiments, the present embodiment is not limited to the above-described embodiments.

For example, although in the above-described embodiments, a case has been described in which the buffer-full notification unit gives notification that data for buffer capacity is filled in the output buffer, a configuration may be made such that a buffer-full notification unit gives notification that a predetermined amount of image data is stored in an output buffer.

Although in the above-described embodiments, a case has been described in which, as the image forming apparatus according to the embodiment of the invention, a digital multi-function peripheral having a scanner function, a copy function, a printer function, and a facsimile function is applied, the invention is not limited thereto. For example, the invention may be applied to a digital multi-function peripheral having at least two functions from the above-described functions, a printer having only a printer function, or the like.

Various programs which are executed by the image forming apparatus of each of the above-described embodiments may be installed in the image forming apparatus in advance, may be stored in a computer-readable storage medium as files of an installable format or executable format and provided, or may be provided or distributed through a network, such as Internet.

The hardware configuration, the processing procedure, and the like in the above-described embodiments are just for illustration, and this embodiment is not limited thereto.

According to the embodiment of the invention, unauthorized or defective image data can be prevented from being transferred to the image forming member (plotter), so that degradation in quality of image formation can be prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a memory that stores image data;
a first buffer that temporarily stores image data read from the memory;
a buffer-full notification unit that gives a notification that a predetermined amount of image data is stored in the first buffer; and
an image forming unit, the image forming unit having a second buffer that is connected to the first buffer through a bus and temporarily stores image data read from the first buffer, an image forming member that forms an image on a medium on the basis of image data stored in the second buffer, and a read control unit that acquires image data stored in the first buffer through the bus and stores acquired image data in the second buffer, when a read command to read image data stored in the first buffer to store the read image data in the second buffer is generated and the notification is given from the buffer-full notification unit.

2. The image forming apparatus according to claim 1, wherein
the buffer-full notification unit gives the notification through a register, when it is detected that a predetermined amount of image data is stored in the first buffer.

3. The image forming apparatus according to claim 2, wherein
the buffer-full notification unit issues a write request to the register through the bus to give the notification.

4. The image forming apparatus according to claim 1, wherein
the buffer-full notification unit gives the notification through a CPU interruption, when it is detected that a predetermined amount of image data is stored in the first buffer.

5. The image forming apparatus according to claim 1, wherein
the first buffer, the buffer-full notification unit, the second buffer, and the read control unit are prepared for each block of C (cyan), M (magenta), Y (yellow), and K (black).

6. The image forming apparatus according to claim 1, wherein the bus is a PCI Express bus.

7. A method of controlling an image forming apparatus including a memory that stores image data, a first buffer that temporarily stores image data read from the memory, a second buffer that is connected to the first buffer through a bus and temporarily stores image data read from the first buffer, and an image forming member that forms an image on a medium on the basis of image data stored in the second buffer, the method comprising:
giving a notification that a predetermined amount of image data is stored in the first buffer; and
acquiring image data stored in the first buffer through the bus and storing acquired image data in the second buffer when a read command to read image data stored in the first buffer to store the read image data in the second buffer is generated and the notification is given in the giving of the notification.
